(19) United States
(12) Patent Application Publication
(10) Pub. No.: US 2010/0295933 A1
(43) Pub. Date: Nov. 25, 2010

(54) WATERTIGHT MONITORING DEVICE

(75) Inventors: Ming-Feng Hsieh, Taipei City (TW); Wen-Chi Wang, Taipei (TW); Julian Lin, Taipei (TW)

Correspondence Address: ROGER H. CHU, 19499 ERIC DRIVE, SARATOGA, CA, 95070, US

(73) Assignee: VTC ELECTRONICS GROUP, Taipei (TW)

(21) Appl. No.: 12/471,428

(22) Filed: May 25, 2009

(51) Int. Cl. H04N 7/18

(52) U.S. Cl. 348/81; 348/E07.085

(57) ABSTRACT

The present invention discloses a watertight monitoring device and comprises: fixing frame, a watertight cover, an image-capturing module, an upper cover, at least an adjustment tab, at least a plastic film, a front cover, and a rear cover; wherein the fixing frame has an outer surface provided with a recess having at least a through hole, the plastic film having an end coupled with the bottom edge of the adjustment tab and an opposite end passing sequentially through the aperture of the watertight cover and the through hole of the recess on the outer surface of the fixing frame and coupled with the adjustment rod of the image-capturing module, wherein the projecting portion of the adjustment tab can be pushed along the outer surface of the monitoring device so that the adjustment tab is moved in the arc direction, and the plastic film thus driving the adjustment rod of the image-capturing module so as to adjust functions of the image-capturing module.

### BACKGROUND OF THE INVENTION

1. Technical Field

The present invention relates to an improved watertight monitoring device. More particularly, the present invention relates to a monitoring camera wherein a plastic film is used as a driving mechanism for functional adjustment of an image-capturing module, and the plastic film has a very small thickness so as to simultaneously enable focus adjustment and high watertightness of the monitoring camera.

2. Description of Related Art

In order to cope with different application environments, it has been a trend for monitoring cameras to have a watertight function. Early watertight monitoring cameras are mainly composed of a camera body coupled with an optical lens and then sealed altogether in a housing assembly so as to serve image-capturing and watertight purposes. However, as the optical lens is located inside the housing assembly, focus adjustment is possible only after the housing assembly is disassembled, thus causing much inconvenience.

For the sake of providing a solution to the aforesaid problem, thus allowing a user of a watertight monitoring camera to timely adjust a focus of its optical lens or other functions so that a target image can be rapidly and clearly taken, it is necessary to provide an adjustment device protrudingly on a housing of the monitoring camera whereby the user can adjust the optical lens directly or indirectly. In addition, watertight measures must be applied to any openings or gaps of the monitoring camera to prevent water from entering the monitoring camera through such openings or gaps and damaging the optical lens.

Conventional watertight monitoring cameras having a focus adjustment function can be divided, according to the focus adjustment methods employed, into two major types, namely the direct adjustment type and the indirect adjustment type. A brief introduction to monitoring cameras using these two adjustment methods is provided below.

Taiwan Utility Model Patent No. M265622, titled “Watertight Zoom Camera”, discloses a watertight monitoring camera of the direct adjustment type that comprises a main body, an adjustable optical lens, an adjustment ring, a rear cover, and a front cover. The main body forms a receiving space therein and has a sidewall provided with a slot. The adjustable optical lens is provided with an adjustment rod and disposed in the receiving space of the main body, wherein the adjustment rod of the adjustable optical lens corresponds in position to the slot of the sidewall of the main body. The adjustment ring has an inner surface formed with a groove for being fitted correspondingly on the adjustment rod of the adjustable optical lens. In addition, the adjustment ring has a front end coupled with the main body. The rear cover is coupled with a rear end of the adjustment ring. The front cover is coupled with a front end of the main body so as to enclose the adjustable optical lens therein. Connecting portions of the aforesaid components are coupled to one another by a close fit design. Thus, as the adjustment ring is configured to drive the corresponding adjustment rod, a zoom factor and a focus of the adjustable optical lens are adjustable from outside while watertightness is ensured. However, since the adjustment mechanism (i.e., the adjustment ring) is directly coupled with the adjustment rod of the adjustable optical lens, and the adjustment ring requires a large displacement, the watertight monitoring camera must have a significantly increased watertight path. While a rubber O-ring is typically used as the watertight medium, it has relatively high forming variability and, on the premise that rotatability of the adjustment ring and watertightness must be concurrently achieved, it is required that components for use with the O-ring have relatively high precision. As a result, the O-ring has a low yield factor in mass production and seldom conforms to the specification for high watertightness.

Next, according to Taiwan Utility Model Patent No. M261939, titled “Outdoor Watertight Monitoring Camera”, a watertight monitoring camera of the indirect adjustment type is provided wherein an image-capturing lens is disposed in a sealed housing assembly to enable outdoor watertightness, and an adjustment seat comprising two adjustment blocks for adjusting magnetic force-applying bodies is provided outside the housing assembly. The two adjustment blocks correspond in position to magnetic force-applying bodies on a focusing ring and a zoom ring of the image-capturing lens, respectively. Thus, a focus of the image-capturing lens sealed inside the housing assembly is adjustable through attraction at a distance between the magnetic force-applying bodies on the focusing ring and the zoom ring and the adjustment blocks. According to the disclosure of this patent, the focus of the image-capturing lens is adjusted by the adjustment blocks at a distance so that watertightness of the image-capturing lens is effectively accomplished. However, as the magnetic force-applying bodies on the focusing ring and the zoom ring are driven by magnetic inductance across the housing assembly, the sensitivity in focus adjustment is understandably low, and in consequence error actions tend to occur. Moreover, since components such as the adjustment seat and the magnetic force-applying bodies must be separately made and then assembled to the housing assembly by an additional installation operation, the overall manufacturing process is economically inefficient considering its complexity, the inconvenience caused, and the elevated cost.

Besides, Taiwan Utility Model Patent No. M309690, titled “Watertight Monitoring Camera Having Zoom Adjustment Device (II)”, also teaches a watertight monitoring camera of the indirect adjustment type. This watertight monitoring camera is characterized by comprising a first adjustment rod which is penetratingly provided on a housing and directly screwed to a first adjusting element coupled with a first linking element of a focusing ring, and a second adjustment rod which is penetratingly provided on the housing and directly screwed to a second adjusting element coupled with a second linking element of a zoom ring. By adjusting the first adjustment rod and the second adjustment rod on the housing, the first linking element and the second linking element are driven so as to drive the focusing ring and the zoom ring for clockwise or counterclockwise rotation and thus effectuate focus adjustment. Since the various components in the adjustment mechanism are linked and adjusted by means of physical contact, the overall precision of adjustment is relatively high. In addition, watertight washers are installed on the first and second adjustment rods and correspond in position to first and second adjustment grooves, respectively, so as to provide good watertightness. According to this patented design, the watertight path is reduced to a small hole having a diameter of about 5 mm, and gears or screw rods are used as an adjustment driving mechanism for driving the adjusting elements of a lens in an indirect manner and thereby ensuring watertightness. Nevertheless, the adjustment driving mechanism according to this design is rather complicated and requires a high manufacturing cost, thus leaving much room for improvement.

### BRIEF SUMMARY OF THE INVENTION

A first objective of the present invention is to provide an improved watertight monitoring device which uses a plastic film as a driving mechanism for functional adjustment of an image-capturing module. The plastic film has a thickness of only 0.2 mm such that a watertight path of each adjustment mechanism of the monitoring device is only 5 mm×0.2 mm in size, and in consequence high watertightness is easily achieved.

A second objective of the present invention is to provide an improved watertight monitoring device using a plastic film as a driving mechanism for functional adjustment of an image-capturing module, wherein an adjustment tab can be directly pushed from outside the monitoring device so that the functional adjustment of the image-capturing module is driven by the plastic film and successfully carried out. The monitoring device has a very simple adjustment mechanism that brings down the cost of the monitoring device considerably.

A third objective of the present invention is to provide an improved watertight monitoring device using a plastic film as a driving mechanism for functional adjustment of an image-capturing module, wherein the plastic film is highly flexible, incompressible, and substantially unbreakable, thus extending the service life of an adjustment mechanism of the monitoring device.

The present invention provides an improved watertight monitoring device including: a fixing frame having a cylindrical annular structure forming and encircling a receiving space therein, the fixing frame having an outer surface provided with a recess having at least one through hole; a watertight cover closely fitted in the recess and provided with an aperture such that the through hole of the recess is not covered by the watertight cover; an image-capturing module fixedly provided in the receiving space of the fixing frame and including at least one radial adjustment rod; an upper cover to be coupled with and thus cover a portion of the outer surface of the fixing frame and an entire surface of the watertight cover, the upper cover being further provided with at least one adjustment slot having a predetermined length and extended in an arc direction; at least one adjustment tab including a projecting portion and a bottom edge and located between the outer surface of the fixing frame and the upper cover, the projecting portion of the adjustment tab passing through the adjustment slot of the upper cover so as to be exposed at an outer surface of the monitoring device; at least one plastic film having a strip-like structure, the plastic film having an end coupled with the bottom edge of the adjustment tab and an opposite end passing sequentially through the aperture of the watertight cover and the through hole of the recess on the outer surface of the fixing frame so as to enter the receiving space, a portion of the plastic film that is in the receiving space being bonded to an inner surface of the fixing frame and coupled with the adjustment rod of the image-capturing module; a front cover coupled with the fixing frame at an end surface thereof in an image-capturing direction of the image-capturing module; and a rear cover coupled with the fixing frame at an end surface thereof opposite the end surface coupled with the front cover. Therein, the projecting portion of the adjustment tab can be pushed along the outer surface of the monitoring device so that the adjustment tab is moved in the arc direction, and in consequence the plastic film drives the adjustment rod of the image-capturing module so as to adjust functions of the image-capturing module.

### BRIEF DESCRIPTION OF THE SEVERAL VIEWS OF THE DRAWINGS

The invention as well as a preferred mode of use, further objectives, and advantages thereof will be best understood by referring to the following detailed description of an illustrative embodiment in conjunction with the accompanying drawings, wherein:

FIG. 1 is an exploded perspective view of a preferred embodiment of the present invention;

FIG. 2 is an assembled perspective view of the preferred embodiment of the present invention;

FIG. 3 is a side view of the preferred embodiment of the present invention; and

FIG. 4 is a sectional view of the preferred embodiment of the present invention.

### DETAILED DESCRIPTION OF THE INVENTION

In order to achieve the aforesaid objectives and effects, the inventor of the present invention uses a plastic film as a driving mechanism for adjusting functions of an image-capturing module, as well as other simple components for satisfying the need for watertightness, thus obtaining an improved watertight monitoring device as disclosed herein.

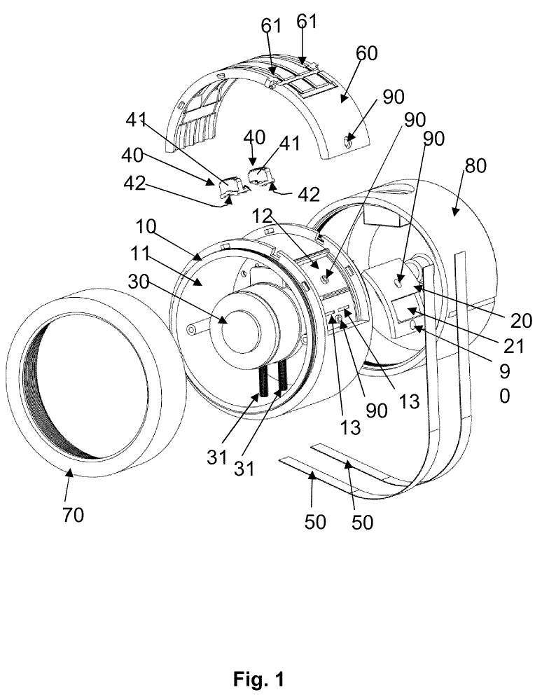

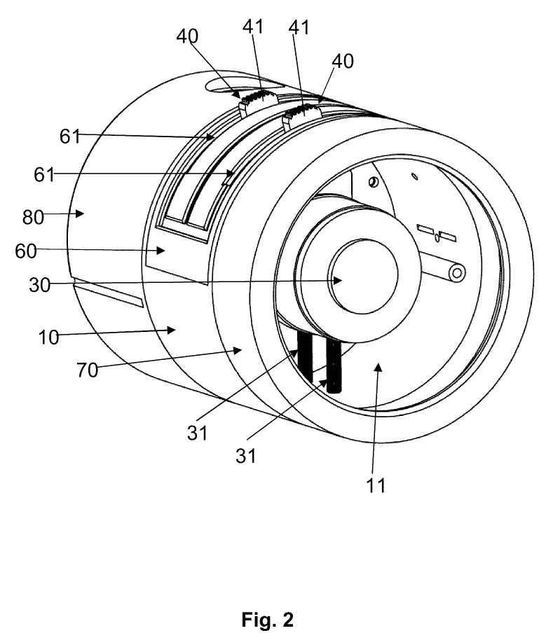

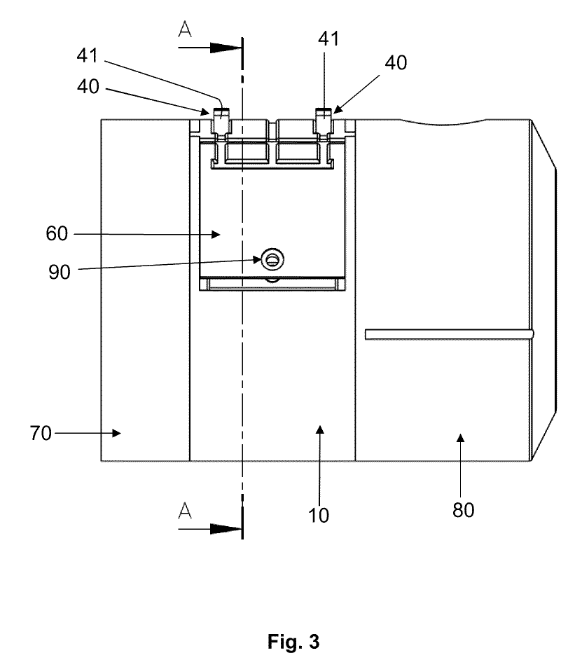

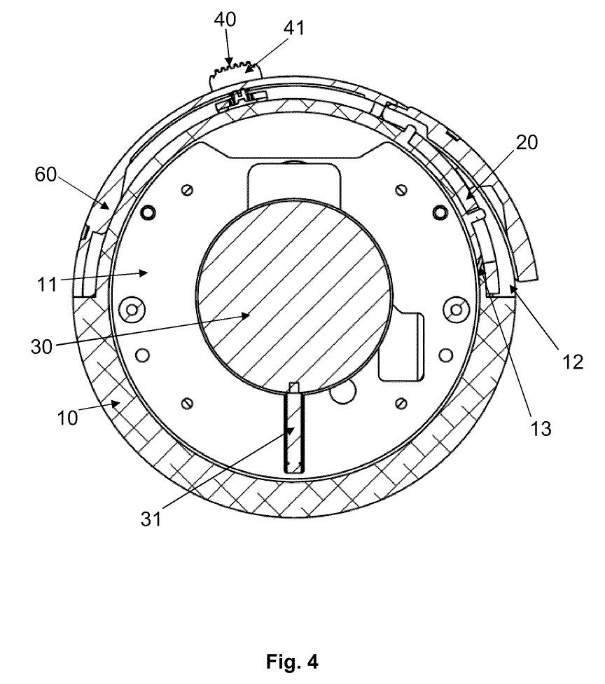

Please refer to FIGS. 1 through 3 for an exploded perspective view, an assembled perspective view, and a side view of an improved watertight monitoring device according to a preferred embodiment of the present invention, respectively, and to FIG. 4 for a sectional view taken along line A-A in FIG. 3. The improved watertight monitoring device includes the following components. A fixing frame 10 has a cylindrical annular structure that forms and encircles a receiving space 11 therein. The fixing frame 10 has an outer surface provided with a recess 12 having at least one through hole 13. A watertight cover 20 made of rubber and closely fitted in the recess 12 is provided with an aperture 21 which prevents the through hole 13 of the recess 12 from being covered by the watertight cover 20. An image-capturing module 30 is fixedly provided in the receiving space 11 of the fixing frame 10 and includes at least one radial adjustment rod 31. An upper cover 60 is coupled with and thus covers a portion of the outer surface of the fixing frame 10 and an entire surface of the watertight cover 20. The upper cover 60 is further provided with at least one adjustment slot 61 having a predetermined length and extended in an arc direction. At least one adjustment tab 40 includes a projecting portion 41 and a bottom edge 42 and is located between the outer surface of the fixing frame 10 and the upper cover 60. The projecting portion 41 of the adjustment tab 40 passes through the adjustment slot 61 of the upper cover 60 so as to be exposed at an outer surface of the monitoring device. At least one plastic film 50 of a strip-like structure has an end coupled with the bottom edge 42 of the adjustment tab 40 and an opposite end passing sequentially through the aperture 21 of the watertight cover 20 and the through hole 13 of the recess 12 on the outer surface of the fixing frame 10 so as to enter the receiving space 11. A portion of the plastic film 50 that is in the receiving space 11 is bonded to an inner surface of the fixing frame 10 and coupled with the adjustment rod 31 of the image-capturing module 30. A front cover 70 is coupled with the fixing frame 10 at an end surface thereof in an image-capturing direction of the image-capturing module 30. Finally, a rear cover 80 is coupled with the fixing frame 10 at an end surface thereof opposite the end surface coupled with the front cover 70. Therein, the projecting portion 41 of the adjustment tab 40 can be pushed along the outer surface of the monitoring device so that the adjustment tab 40 is moved in the arc direction, and in consequence the plastic film 50 drives the adjustment rod 31 of the image-capturing module 30 so as to adjust functions of the image-capturing module 30.

The plastic film 50 has a thickness of only 0.2 mm. Therefore, the through hole 13 of the recess 12 on the outer surface of the fixing frame 10 only need to be 5 mm×0.2 mm in size. This through hole 13 also forms a watertight path of the improved watertight monitoring device. Compared with the conventional watertight image-capturing devices, the watertight monitoring device according to the present invention has a significantly reduced watertight path that can be easily implemented by a simple structure.

In addition, the upper cover 60, the watertight cover 20, and the fixing frame 10 are each provided with at least one screw fastening hole 90 at a corresponding position, allowing the these three components to be fastened together by at least one screw while the adjustment tab 40 and the plastic film 50 are secured in position between the three components and unlikely to get loose. On the other hand, when it is desired to adjust the functions of the image-capturing module 30, this can be done by simply loosening the screw and pushing the projecting portion 41 of the adjustment tab 40.

However, instead of using the aforesaid screw for fastening the upper cover 60, the watertight cover 20, and the fixing frame 10 together, the three components can be coupled together by a hook-like fastening element or similar structures, provided the upper cover 60 and the watertight cover 20 are completely secured in position to the fixing frame 10.

Generally speaking, the image-capturing module 30 has such common functional adjustment items as focus adjustment, distance adjustment, and wide-angle adjustment. Nevertheless, the image-capturing module 30 may be integrated with many more functional adjustment items as needed. In the preferred embodiment of the present invention, the quantity of each of the adjustment tab 40, the plastic film 50, and the adjustment rod 31 can be increased or decreased according to the number of functional adjustment items applicable to the image-capturing module 30. For example, if the image-capturing module 30 is capable of focus adjustment and wide-angle adjustment only, the quantity of each of the adjustment tab 40, the plastic film 50, and the adjustment rod 31 is two, wherein each adjustment tab 40 and its corresponding plastic film 50 and adjustment rod 31 form a set of adjustment mechanism. In other words, there are two sets of adjustment mechanisms in the above example, and each set of adjustment mechanism is responsible for performing either focus or wide-angle adjustment for the image-capturing module 30.

With the rapid development and evolution of electronic products, the level of dust and water protection required of electronic products becomes higher and higher. In order to provide certain criteria for rating dust and water protection levels, the Electrical Installation Equipment Manufacturers' Association (EIEMA), an international organization of standardization, established a worldwide standard for the dustproof and watertight functions of electronic products, namely the International Protection Code (IP Code) rating system. The IP Code consists of the letters IP and two digits (e.g., IP45), wherein the first digit defines the level (0˜6) of dustproofness, and the second digit defines the level (0˜8) of watertightness.

The dust protection levels include: 0 indicating no protection, 1 indicating protection against ingress of foreign matters larger than 50 mm, 2 indicating protection against ingress of foreign matters larger than 12.5 mm, 3 indicating protection against ingress of foreign matters larger than 2.5 mm, 4 indicating protection against ingress of foreign matters larger than 1 mm, 5 indicating protection against ingress of dust, and 6 indicating a dust-tight condition.

The water protection levels include: 0 indicating no protection, 1 indicating protection against vertically dripping water, 2 indicating protection against dripping water when tilted up to 15°, 3 indicating protection against dripping water when tilted up to 60°, 4 indicating protection against splashing water from any direction, 5 indicating protection against low-pressure splashing water from any direction, 6 indicating protection against relatively high-pressure splashing water from any direction, 7 indicating protection against the effects of submersion in water at a depth of 1 m for a short period of time, and 8 indicating protection against the effects of submersion in water at a depth of 1 m for a long period of time.

Now that watertightness is emphasized in the improved watertight monitoring device according to the present invention, watertightness tests were conducted to verify and improve the watertightness of the present invention. After repeated tests and improvements, the watertight monitoring device according to the present invention successively passed the tests corresponding to water protection levels 1 to 7. Finally, the improved watertight monitoring device according to the present invention was submerged in water at a depth of 1 m for three days, and it turned out that no leakage occurred. Thus, the improved watertight monitoring device according to the present invention reaches the protection level IPX8, with X denoting any dust protection level, which is irrelevant to the water protection level of the present invention.

The embodiment described above is intended only to demonstrate the technical concept and features of the present invention so as to enable a person skilled in the art to understand and implement the contents disclosed herein. It is understood that the disclosed embodiment is not to limit the scope of the present invention. Therefore, all equivalent changes or modifications based on the concept of the present invention should be encompassed by the appended claims.

What is claimed is:

1. A watertight monitoring device, comprising:
a fixing frame having a cylindrical annular structure forming and encircling a receiving space therein, the fixing frame having an outer surface provided with a recess having at least a through hole;
a watertight cover closely fitted in the recess and provided with an aperture such that the through hole of the recess is not covered by the watertight cover;
an image-capturing module fixedly provided in the receiving space of the fixing frame and comprising at least a radial adjustment rod;
an upper cover to be coupled with and thus cover a portion of the outer surface of the fixing frame and an entire surface of the watertight cover, the upper cover being further provided with at least an adjustment slot having a predetermined length and extended in an arc direction;
at least an adjustment tab comprising a projecting portion and a bottom edge and located between the outer surface of the fixing frame and the upper cover, the projecting portion of the adjustment tab passing through the adjustment slot of the upper cover so as to be exposed at an outer surface of the monitoring device;
at least a plastic film having a strip-like structure, the plastic film having an end coupled with the bottom edge of the adjustment tab and an opposite end passing sequentially through the aperture of the watertight cover and the through hole of the recess on the outer surface of the fixing frame so as to enter the receiving space, a portion of the plastic film that is in the receiving space being bonded to an inner surface of the fixing frame and coupled with the adjustment rod of the image-capturing module;
a front cover coupled with the fixing frame at an end surface thereof in an image-capturing direction of the image-capturing module; and
a rear cover coupled with the fixing frame at an end surface thereof opposite the end surface coupled with the front cover;
wherein the projecting portion of the adjustment tab can be pushed along the outer surface of the monitoring device so that the adjustment tab is moved in the arc direction, and the plastic film thus driving the adjustment rod of the image-capturing module so as to adjust functions of the image-capturing module.

2. The watertight monitoring device of claim 1, wherein the plastic film has a thickness of 0.2 mm.

3. The watertight monitoring device of claim 1, wherein the through hole of the recess on the outer surface of the fixing frame has a size of 5 mm×0.2 mm and forms a watertight path of the watertight monitoring device.

4. The watertight monitoring device of claim 1, wherein the watertight cover is made of rubber.

5. The watertight monitoring device of claim 1, wherein each of the upper cover, the watertight cover, and the fixing frame is provided with at least a screw fastening hole at a corresponding position, thus allowing the upper cover, the watertight cover, and the fixing frame to be fastened together by at least a screw so that the adjustment tab and the plastic film are secured in position between the upper cover, the watertight cover, and the fixing frame without getting loose, and the functions of the image-capturing module are adjustable by loosening the screw and pushing the projecting portion of the adjustment tab.

6. The watertight monitoring device of claim 1, wherein the upper cover, the watertight cover, and the fixing frame are coupled together and secured in position relative to one another by a hook-like fastening structure
